(19) United States
(12) Patent Application Publication
(10) Pub. No.: US 2015/0075409 A1
(43) Pub. Date: Mar. 19, 2015

(54) ADJUVANT FOR HYDRAULIC COMPOSITIONS

(71) Applicant: CHRYSO, Issy Les Moulineaux (FR)

(72) Inventors: Sandra Darguy, Etampes (FR); David Babayan, Aarau Rohr (CH)

(21) Appl. No.: 14/390,683

(22) PCT Filed: Apr. 5, 2013
(86) PCT No.: PCT/EP2013/057231

§ 371 Date: Oct. 3, 2014

(30) Foreign Application Priority Data
Apr. 5, 2012 (FR) 12 53165

(51) Int. Cl. C04B 24/16; C04B 14/04; C04B 24/02

(52) U.S. Cl. CPC C04B 24/16; C04B 24/02; C04B 14/04
USPC 106/810; 106/823

(57) ABSTRACT

The invention is mainly directed to an admixture in the form of an aqueous dispersion, comprising:
mineral nanoparticles;
an accelerator for setting hydraulic compositions; and
a dispersant polymer,

wherein the pH is comprised between 2 and 11, to a method for its preparation as well as to the preparation of a hydraulic composition as well as to its use for accelerating the setting of hydraulic compositions.

### FIELD OF THE INVENTION

The present invention relates to an admixture, a method for its preparation and to its use for accelerating the setting of hydraulic compositions.

### BACKGROUND OF THE INVENTION

It is customary to add to hydraulic compositions, admixtures in order to modulate the properties thereof during application and after hardening.

Modification of hydraulic setting characteristics by adding setting accelerators and setting retarders is thereby known.

The setting accelerator is economically of particular interest since it allows an increase in the manufacturing throughput and also allows working under winter conditions.

Certain salts, notably alkaline salts like sodium chloride or earth-alkaline salts like calcium chloride, are widely used as accelerators for setting and hardening hydraulic compositions based on Portland cement.

The capability of these salts of improving mechanical strengths in compression may, however, be limited in the case of cements with a low clinker content, these salts more particularly accelerating the hydration of the phases of the clinker.

For example from WO0198227, it is also known that mineral particles in colloidal form may provide an interesting mechanical strength and moreover have a setting accelerator effect. However, the effect on the mechanical strength appears much later, about 6 hours after setting.

Now for example from the textbook “Techniques de l'Ingénieur, Traité Génie des procédés” (engineering techniques, process engineering treatise), J 2 185-1, Section 3.2.), it is known that colloidal dispersions like sols are easily destabilized, notably in the presence of salts which leads to aggregation of the particles.

According to WO 98/12149, the aggregation of colloidal silica may generate encapsulation of cement particles which has the effect of reducing resistance to compression in the long term.

The application WO 01/90024 describes the joint addition of a silica sol and of a super-plasticizer with view to extending the workability and limit the bleeding phenomenon of a fluid concrete composition.

The application WO 2008/046831 describes stable dispersions in an alkaline medium comprising a precipitated silica sol and a plasticizer in order to improve resistance to compression at an early stage.

### SUMMARY OF THE INVENTION

The object of the invention is to propose an admixture based on mineral nanoparticles with the purpose of accelerating the setting of hydraulic compositions, which is more economical.

Another object is to propose such an admixture in the form of a stable formulation.

The objects mentioned above are achieved according to the invention by associating in an admixture, mineral nanoparticles, a setting accelerator and a dispersing polymer.

Indeed, the presence of a setting agent in addition to the mineral nanoparticles gives the possibility of reducing the dose of nanoparticles and of thereby optimizing the cost. Unexpectedly, it was seen that it is possible to obtain a stable formulation of such an admixture even in the presence of a setting accelerator as a salt, when the admixture further contains a dispersant polymer.

Advantageously, the dispersant polymer stabilizes the nanoparticles also after introducing into the composition a hydraulic binder, and thus gives the possibility of improving the efficiency thereof.

Finally, the presence of several setting accelerators in the admixture gives the possibility of modulating the progress over time of the accelerator effect. In particular, it is possible to obtain an effect even before 6 h, and to thereby improve the compression resistances at early and very early stages.

Also, according to a first aspect, the invention is directed to an admixture in the form of an aqueous dispersion, comprising:
mineral nanoparticles;
an accelerator for the setting of hydraulic compositions; and
a dispersant polymer,
   wherein the pH is comprised between 2 and 11.

The mineral nanoparticles may be selected from nanoparticles of silica, alumina and calcium carbonate, optionally modified. Preferably, these are nanoparticles of silica or alumina. They may in particular be contained in a sol.

The nanoparticles may have a charge, notably a negative charge, and therefore be anionic.

The admixture may notably include 1 to 95%, preferably 5 to 50% and most particularly 5 to 20% by weight of nanoparticles.

Preferably, the setting accelerator is selected from glycerol, an alkaline metal salt, an earth-alkaline metal salt, or an aluminum salt, an alkanolamine or their combinations.

The setting accelerator may in particular be a calcium salt selected from calcium chloride, calcium thiocyanate, calcium nitrite and calcium nitrate.

Alternatively, the setting accelerator may be an alkanolamine selected from diethanol amine, methyl diethanol amine, triethanol amine, tetrahydroxyethylene ethylene diamine or triisopropanol amine.

Preferably, the dispersant polymer is selected from polymers also having a dispersant function for the cement in hydraulic binders such as polyalkoxylated polycarboxylic polymers, polyalkoxylated polyphosphonate polymers, polynaphthalene sulfonates (PNS) or formaldehyde and sulfonated melamin polycondensates (PMS).

The dispersant polymer may be anionic, for example contain units with a carboxylate, sulfate, sulfonate, phosphate or phosphonate function.

Advantageously, the dispersant polymer is an alkaline polyoxide polycarboxylate comprising at least 50%, preferably at least 75% by number of a random linear sequence of structural units (1) and (2) illustrated by the following formulae:

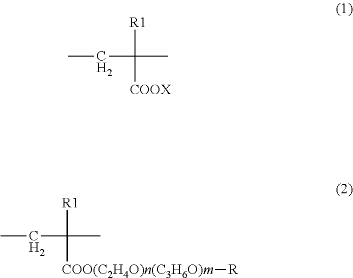

in which X represents a hydrogen atom, an alkaline metal, an earth-alkaline metal or an ammonium, said structural units (1) may be identical or different; R1 is a hydrogen atom or a methyl group; n is an integer varying from 0 to 120, m is an integer varying from 0 to 100 with m<n, the propylene oxide groups may either be randomly distributed or not from among ethylene oxide groups, R represents a hydrogen atom, an alkyl or alkenyl group with 1 to 24, preferably 1 to 18 carbon atoms, said structural units (2) may be identical or different; the ratio of the number of structural units (2), over the total number of structural units (1) and (2), being comprised between 5 and 65%, preferably between 40 and 60%.

A polymer according to the formulae above is more preferred, in which X is a hydrogen atom or an earth-alkaline cation, notably a calcium cation.

Alternatively, the dispersant polymer may be a cationic polymer, for example contain units bearing one or several primary, secondary, tertiary and/or quaternary amine groups.

According to another alternative, the dispersant polymer may be an amphoteric polymer.

According to a preferred embodiment, the dispersant polymer is a polyalkoxylated poly-carboxylic polymer, for which at least one portion of the carboxylic functions are found as a salt, notably with a multivalent cation such as a calcium cation. Indeed, the presence of multivalent cations gives the possibility of making this polymer normally anionic, compatible with anionic mineral nanoparticles, which are less expensive and more easily available, by giving it a positive charge.

Advantageously, the admixture described has a pH comprised between 3 and 10. According to a second aspect, the invention is directed to a method for preparing an admixture comprising, in this order or in a different order, the steps of:
(1) providing an aqueous solution of mineral nanoparticles;
(2) adding a dispersant polymer;
(3) adding a setting agent; and
(4) if necessary, adjusting the pH to a value from 2 to 11.

According to a third aspect, the invention is directed to a method for preparing a hydraulic composition, comprising the adding of a suitable dose of the admixture according to invention to the hydraulic composition, preferably upon mixing.

The suitable dose of admixture may in particular be from 500 to 10,000 ppm by dry weight, based on the weight of the hydraulic binder.

According to a fourth aspect, finally, the invention is directed to the use of the admixture according to the invention with view to accelerating the setting of a hydraulic composition.

### DETAILED DESCRIPTION OF THE EMBODIMENTS

Within the scope of the present discussion, the term of “nanoparticles” is meant to designate particles having a number average size of less than 100 nm, and preferably comprised in a range from 5 to 50 nm.

The term <<sol>> designates a stable dispersion of colloidal particles within a liquid. By definition, colloidal particles have a size comprised between 1 nm and 1 μm and thereby encompass nanoparticles. In a sol, the size of the colloidal particles should be sufficiently small so that the Brownian motion counter-balances gravity and allows the particles to be maintained in suspension.

By the term of <<dispersion>> is meant the targeting of a liquid medium in which a solid is dispersed, in the present case, mineral nanoparticles.

By the term of <<polymer>> is meant a compound derived from the polymerization of at least one monomer species. The most often, when it results from the polymerization of several monomers, the units may be present in the co-polymer with a random, alternating, statistical or sequenced linkage. The obtained polymer may be modified after polymerization, for example by esterification or neutralization of carboxylic groups.

The term of <<dispersant polymer>> is meant to designate a polymer having the effect of improving the dispersion of particles, notably of mineral nanoparticles. Generally, but not necessarily, it has a polar portion which may interact with the surface of the nanoparticles, via an electrostatic interaction, covalent grafting, hydrogen bond or other bonds, and a portion which, by steric hindrance, limits the approach of mineral particles to each other and consequently their agglomeration.

The expression of <<cationic polymer>> means a polymer containing cationic groups or ionizable groups into cationic groups.

The expression <<anionic polymer>> means a polymer containing anionic groups or groups which may be ionized into anionic groups.

The term of <<hydraulic composition>> means compositions comprising water and at least one hydraulic binder.

By the term of <<hydraulic binder>> is meant any compound having the property of hydrating in the presence of water and for which hydration gives the possibility of obtaining a solid having mechanical characteristics, notably a cement such as a Portland cement, an aluminous cement, a pozzolanic or further an anhydrous calcium sulfate or semihydrate. Hydraulic binders based on Portland cement described in the NF EN 197-2 standard may further include pozzolanic materials such as blast furnace slags, flying ashes, natural pozzolans, silica fumes. The hydraulic binder may in particular be a cement according to the EN 197-1 standard and notably a Portland cement, and in particular a cement of the CEM I, CEM II, CEM III, CEM IV or CEM V type according to the Cement NF EN 197-1 standard.

Hydraulic binders based on Portland cement may further include mineral additions. The expression of <<mineral additions>> designates slags (as defined in the Cement NF EN 197-1 paragraph 5.2.2 standard), steel working slags, pozzolanic materials (as defined in the Cement NF EN 197-1 paragraph 5.2.3 standard), flying ashes (as defined in the Cement NF EN 197-1 paragraph 5.2.4 standard), calcined shales and clays (as defined in the Cement NF EN 197-1 paragraph 5.2.5 standard), limestones (as defined in the Cement NF EN 197-1 paragraph 5.2.6 standard) or further silica fumes (as defined in the Cement NF EN 197-1 paragraph 5.2.7 standard) or mixtures thereof. Other additions, not presently recognized by the Cement NF EN 197-1 (2001) standard, may also be used. These are notably metakaolins, such as metakaolins of type A compliant with the NF P 18-513 standard, and siliceous additions, such as siliceous additions with Qz mineralogy compliant with the NF P 18-509 standard.

By the term of <<setting accelerator>> is meant a compound for which the presence in the hydraulic composition increases the hydraulic setting rate of the composition, except for the mineral nanoparticles, designated as such. Their performances are notably indicated in the US standard ASTM C494.

In the following and unless indicated otherwise, the admixture doses are understood by dry weight, based on the weight of hydraulic binder.

The admixture according to the invention allows the preparation of hydraulic compositions having reduced setting time and further good resistance to compression at an early stage, notably at 1, 2, 7 and 28 days, as well as at very early stages, notably from 4 to 16 h, while being economical.

The admixture according to the invention first of all contains mineral nanoparticles. These mineral nanoparticles have the effect of accelerating the hydration reaction in the hydraulic composition, which is expressed by reduced setting time. In parallel, the nanoparticles give the possibility of obtaining resistances to compression at an early stage which are very interesting, notably at 1 day and before.

Although the action mechanism for accelerating the setting of hydraulic compositions of nanoparticles is not completely elucidated, it is presently assumed that the nanoparticles are used as nucleation sites allowing the growth of hydrates, in particular of CSH (acronym for “Calcium Silicate Hydrate”).

The mineral nanoparticles are preferably oxides, and notably of silica, alumina or then of calcium carbonate. These nanoparticles may optionally be modified by including other cations.

The silica may notably be precipitated silica, but it may also be pyrogenated silica.

The number average size of the mineral nanoparticles is preferably comprised between 5 and 200 nm, preferably between 10 and 50 nm. According to an embodiment, the nanoparticles are monodispersed.

Because of their small size, the specific surface area of the nanoparticles is relatively high. Preferably it is comprised between 10 and 700, and in particular between 50 and 500 m²/g.

Preferably, the added nanoparticles appear as a sol.

Such sols are available commercially, and relating to precipitated silicas, sold under the name of BINDZIL (by EKA) or KLEBOSOL (by AZEM).

The majority of the silica sols available are anionic silicas, due to the presence at their surface of Si—OH groups, stabilized by cations such as sodium, aluminum, ammonium or hydrogen.

Cationic silicas, however, also exist, which may notably be obtained by a surface coating with alumina, which are stabilized by anions, notably the chloride anion.

The surface charge of mineral nanoparticles may be determined by measuring its surface potential ξ.

The admixture preferably includes from 1 to 95, advantageously from 5 to 50, preferably between 5 to 20% by dry weight of mineral nanoparticles.

The admixture according to the invention secondly comprises a dispersant polymer.

The presence in the admixture of a dispersant polymer gives the possibility of stabilizing the nanoparticles in the hydraulic composition and thereby optimizes their efficiency. Moreover, it gives the possibility of stabilizing the nanoparticles in the formulation, notably towards ion interactions with setting accelerator salts, so as to widen the formulation possibilities for the admixture according to the invention.

In order to optimize its affinity with nanoparticles, the dispersant polymer is advantageously selected from the cationic type when the nanoparticles are anionic and vice versa.

In this scope, it is of interest to be able to locally reverse the charge of a polymer, by forming a complex with a multivalent ion of an opposite charge to its own. This local inversion may be sufficient for allowing its adsorption on a particle of the same charge as the original charge of the polymer.

Preferably, the dispersant polymer is a polymer also having a dispersant function for the cement in hydraulic binders such as polyalkoxylated poly-carboxylic polymers, polyalkoxylated polyphosphonate polymers, polynaphthalene sulfonates (PNS) or formaldehyde and sulfonated melamin polycondensates (PMS).

The dispersant polymer may be anionic, for example contain units with a carboxylate, sulfate, sulfonate, phosphate or phosphonate function. These units may be part of the main chain or be borne by a lateral substituent.

More preferred are the homo- or co-polymers of carboxylic acids such as polyacrylic acid or comb polymers as described in FR 2 776 285, homo- or co-polymers of sulfonated monomers, such as sodium AMPS, sodium vinyl sulfonate or sodium styrene sulfonate, polymers bearing phosphonate functions such as those described in EP 0 663 892, or further anionic polymers of natural origin or derived from natural raw materials such as calcium or sodium lignosulfonate, in particular lignosulfonates based on a sugar content. Mention may notably also be made of the resins obtained from formaldehyde and sulfonated naphthalene or melamin, or from formaldehyde, urea and sulfonated melamin or further polymers derived from lignosulfonates as well as polyalkoxylated polyphosphonates.

Polyalkoxylated polycarboxylates (also designated as polyalkylene oxide polycarboxylates) are more preferred since they have an excellent dispersant power, including in the hydraulic composition.

A polyalkylene oxide polycarboxylate is more preferred as a dispersant polymer, comprising at least 50%, preferably at least 75% by number of a random linear sequence of structural units (1) and (2) illustrated by the following formulae:

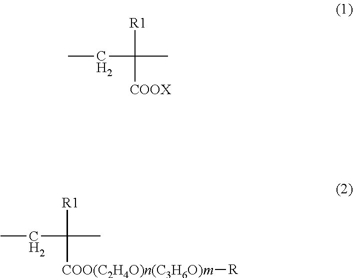

wherein X represents a hydrogen atom, a alkaline metal, an earth-alkaline metal or an ammonium, said structural units (1) may either be identical or different; R1 is a hydrogen atom or a methyl group; n is an integer varying from 0 to 120, m is an integer varying from 0 to 100 with m<n, the proplylene oxide groups may either be randomly distributed or not from among ethylene oxide groups, R represents a hydrogen atom, an alkyl or alkenyl group with 1 to 24, preferably 1 to 18 carbon atoms, said structural units (2) may be identical or different; the ratio of the number of structural units (2), over the total number of structural units (1) and (2), being comprised between 5 and 65%, preferably between 40 and 60%.

As an example of other structural units which may be present, mention may be made of units formed from unsaturated monomers comprising sulfonated, phosphonated groups or alkyl ester groups.

According to a preferential alternative, the dispersant of the polycarboxylic type comprises at least 90% by number of structural units (1) and (2), more preferentially 100% by number of structural units (1) and (2), while not considering the units being used as chain terminations related to polymerization initiation methods and chain length control methods.

According to a preferred embodiment, the dispersant polymer is a polyalkoxylated polycarboxylic polymer of the above formula in which X═H or an earth-alkaline metal and notably Ca.

Indeed, as already mentioned, the presence of multivalent cations gives this anionic polymer a positive charge, which makes it of particular interest for anionic mineral nanoparticles, which are less expensive and more easily available.

Alternatively, the dispersant polymer may be a cationic polymer, for example contain units bearing one or several primary, secondary, tertiary and/or quaternary amine groups. These units may be part of the polymeric chain or be borne by a lateral substituent.

Among these cationic dispersant polymers, mention may be made in particular of quaternized proteins, quaternized polysiloxanes, polymers of the polyamine, polyaminoamide and quaternary polyammonium type, vinyl-pyrrolidone-dialkylaminoalkyl acrylate or methacrylate copolymers, acrylamide and dimethylaminoethyl acrylate (MADAME) copolymers and derivatives thereof, polyDADMAC (diallyldimethyl ammonium chloride) and derivatives thereof, cationic polysaccharides such as derivatives of cellulose or starch ethers including quaternary ammonium groups, polyalkylene imines in particular polyethyleneimines, polymers containing vinylpyridine or vinylpyridinium units, condensates of polyamines and of epichlorhydrin, quaternary polyureylenes and derivatives of chitin.

According to another alternative, the dispersant polymer may be an amphoteric or zwitterionic polymer. Among these amphoteric or zwitterionic dispersant polymers, mention may be made of polymers bearing a function of the amino acid, betaine, sulfobetaine or carboxybetaine type.

Preferably, the dispersant polymers have a number average molar mass comprised between 1,000 and 100,000 g/mol, preferably between 7,000 and 50,000 g/mol.

The admixture preferably includes from 0.1 to 80, advantageously from 0.5 to 60, preferably between 1 to 30% by dry weight of dispersant polymer.

The admixture according to the invention finally comprises a setting accelerator.

Preferably, the setting accelerator is selected from salts, glycerol and alkanolamines.

More preferred from among the setting accelerators in the form of salts are nitrates of an alkaline metal, of an earth-alkaline metal, of aluminum, notably sodium and calcium nitrate; nitrites of an alkaline, earth-alkaline metal or of aluminum, notably sodium and calcium nitrite; thiocyanates of an alkaline, earth-alkaline or aluminum metal notably sodium thiocyanate and calcium thiocyanate; thiosulfates of an alkaline, earth-alkaline or aluminum metal; hydroxides of an alkaline, earth-alkaline metal or of aluminum, notably sodium and calcium hydroxide; carboxylic acid salt of an alkaline, earth-alkaline metal or of aluminum (for example calcium formate); halides of an alkaline, earth-alkaline metal, notably sodium and calcium bromide and chloride, and combinations thereof.

Among the alkaline or earth-alkaline salts, sodium and calcium salts are preferred because of their good compatibility with the hydraulic composition.

Among these salts, calcium chloride, thiocyanate, nitrite and nitrate and sodium thiocyanate are more preferred.

Salts having solubility in water of more than 1 g/l are preferred.

Glycerol represents another efficient accelerator.

Alternatively, the setting accelerator may be an alkanolamine selected from dialkanolamines, alkyldialkanolamines, trialkanolamines, and tetraalkanoldiamines. These amines preferably bear a linear or branched alkyl or alkanol group and comprising 1 to 4 carbon atoms, and preferably 2 to 3 carbon atoms.

From among alkanolamines, are more preferred diethanolamine, methyldiethanolamine, triethanolamine (TEA), tetrahydroxyethylene ethylene diamine (THEED) or triisopropanolamine (TIPA).

The admixture preferably includes from 0.1 to 80, advantageously from 0.5 to 70, preferably between 1 to 60% by dry weight of setting accelerator.

The admixture according to the invention appears in the form of an aqueous dispersion having a pH comprised between 2 and 11, and in particular comprised between 3 and 10. This pH is preferred in order to ensure compatibility of the charges of the dispersant polymer and of the nanoparticles to be dispersed.

Indeed, the surface charge of the nanoparticles depends on the pH, since they involve the reaction of groups at the surface of the nanoparticles with H⁺ or OH⁻ species. The suitable pH for the admixture according to the invention then in particular depends on the isoelectric point, which is defined as the pH at which the charges of the nanoparticles are compensated. Now, the isoelectric point is specific to each chemical species, since it has a value of about 3 for silica, but about 9 for alumina.

The admixture according to the invention may moreover contain other usual additives such as air entrainers, anti-foam agents or corrosion inhibitors.

According to a second aspect, the invention is directed to a method for preparing an accelerating admixture for hydraulic compositions comprising in this order or in a different order, the steps of:
(1) providing an aqueous solution of mineral nanoparticles;
(2) adding a dispersant polymer;
(3) adding a setting accelerator; and
(4) if necessary, adjusting the pH to a value from 2 to 11.

According to a third aspect, the invention is directed to a method for preparing a hydraulic composition, comprising the step for adding an admixture according to the invention to the hydraulic binder upon mixing.

The admixture is preferably used at the moment of the preparation of the hydraulic composition, for example by addition into the mixing water.

Preferably, this method is applied in that the admixture is added with a dose of 500 to 10,000 ppm by weight based on the weight of the hydraulic binder.

The method for preparing a hydraulic composition according to the invention is particularly useful for hydraulic binders, notably those based on a cement having a low C3A content, for which conventional accelerators have little effect, the silica having an effect on the C3S phase.

According to a fourth aspect, the invention is finally directed to the use of the admixture according to the invention with view to accelerating the setting of a hydraulic composition.

The invention will be better explained with reference to the examples which follow, given as non-limiting examples.

### EXAMPLES

### Example 1

In a suitable flask, a cement slurry of the CEM I 52 (5N PMES type Le Havre) with a water to cement (W/C) mass ratio of 0.5, by adding to the mixing water 1,600 ppm of silica nanoparticles (sold under the reference of BINDZIL 515), 500 ppm of glycerol as a setting accelerator admixture and 2,400 ppm of dispersant polymer P partly neutralized with NaOH, as specified in Table 1 below. The polymer P is a polyalkoxylated poly-carboxylic polymer including 80% of units of formula (1) for which R1 is a methyl and 80% of units of formula (2) for which R1 is also a methyl, R is a methyl, n has the value 45 and m has the value 0.

### Example 2

In a suitable flask, a cement slurry is prepared of the CEM I 52 (5N PMES type Le Havre) with a water to cement (W/C) mass ratio of 0.5, by adding to the mixing water a 1,600 ppm of silica nanoparticles (sold under the reference of BINDZIL 515), 500 ppm of sodium thiocyanate as a setting accelerator admixture and 2,400 ppm of dispersant polymer P (in the form of a solution, partly neutralized with NaOH), as specified in Table 1 below.

### Example 3

In a suitable flask, a cement slurry is prepared of the CEM I 52 (5N PMES type Le Havre) with a water to cement (W/C) mass ratio of 0.5, by adding to the mixing water, 1,600 ppm of silica nanoparticles (sold under the reference of BINDZIL 515), 500 ppm of sodium thiocyanate and 500 ppm of glycerol as setting accelerator admixtures and 2,400 ppm of dispersant polymer P partly neutralized with NaOH), as specified in Table 1 below.

### Examples 4 to 6

Examples 1 to 3 are repeated except that the dispersant polymer is replaced with a dispersant polymer P partly neutralized with Ca(OH)₂

### Example 7

### Comparative Example

Example 1 is repeated except that no setting accelerator is added.

### Example 8

### Comparative Example

Example 4 is repeated except that no setting accelerator is added.

TABLE 1
Composition of the admixture

| | Silica | | Setting |
|---|---|---|---|
| EXAMPLE | nanoparticles | Dispersant polymer | accelerator |
| 1 | BINDZIL 515 | P—NaOH | Glycerol |
| 2 | BINDZIL 515 | P—NaOH | NaSCN |
| 3 | BINDZIL 515 | P—NaOH | Glycerol + |
| | | | NaSCN |
| 4 | BINDZIL 515 | P—Ca(OH)₂ | Glycerol |
| 5 | BINDZIL 515 | P—Ca(OH)₂ | NaSCN |
| 6 | BINDZIL 515 | P—Ca(OH)₂ | Glycerol + |
| | | | NaSCN |
| 7 | BINDZIL 515 | P—NaOH | — |
| 8 | BINDZIL 515 | P—Ca(OH)₂ | — |

Study by Isothermal Calorimetry

Isothermal calorimetric measurements were conducted on the samples prepared in the examples above in order to study the effect of the admixture according to the invention on the hydraulic setting process. Isothermal calorimetry gives the possibility of measuring the heat emitted over time during the first hours of the setting of a hydraulic binder.

Immediately after preparation, the flask is introduced with the slurry into an isothermal calorimetry device set to a temperature of 20° C. and then the emitted heat is recorded for a period of 65 h.

The results of the measurement are gathered in Table 2 below.

They show that the total heat versus time is greater for the slurry including the admixture according to the invention, as compared with admixtures including the nanoparticles with the accelerator alone or with the dispersant polymer alone.

The association of the silica nanoparticles with a dispersant polymer and a setting accelerator therefore gives the possibility of increasing the accelerating effect for an equal dose of silica.

TABLE 2
Accumulated heat flow at 6 h and 8 h

| | Q (6 h) | Q (8 h) |
|---|---|---|
| EXAMPLE | [J/g] | [J/g] |
| 1 | 16.6 | 19.8 |
| 2 | 14.7 | 17.5 |
| 3 | 16.8 | 19.9 |
| 4 | 14.1 | 16.7 |
| 5 | 18.1 | 22.3 |
| 6 | 15.6 | 18.0 |
| 7 | 13.3 | 15.8 |
| 8 | 13.6 | 16.0 |

The obtained results above show that in the presence of the three components of the admixture according to the invention, it is possible to clearly increase the setting acceleration effect as compared with an admixture including the nanoparticles associated with a setting accelerator or with a dispersant polymer alone.

Generally, the resistances to compression are placed in the same order as the evolved heat. It should therefore be concluded that the resistances to compression are improved, notably at a very early stage, i.e. before 8 h.

The experimental data above thus confirm the benefit of the association of silica nanoparticles, of a setting accelerator and of a dispersant polymer in the admixture according to the invention.

1. An admixture in the form of an aqueous dispersion, comprising:
mineral nanoparticles;
an accelerator configured to set hydraulic compositions; and
a dispersant polymer,
wherein the pH is comprised between 2 and 11 and
wherein the mineral nanoparticles are selected from the group consisting of silica, alumina and calcium carbonate nanoparticles, optionally modified.

2. The admixture according to claim 1, wherein the nanoparticles are contained in a sol.

3. The admixture according to of claim 1, wherein the mineral nanoparticles are anionic.

4. The admixture according to claim 1, wherein the setting accelerator is selected from the group consisting of glycerol; an alkaline metal salt, an earth-alkaline metal salt or an aluminum salt; an alkanolamine and a combination thereof.

5. The admixture according to claim 4, wherein the setting accelerator is a calcium salt selected from the group consisting of calcium chloride, calcium thiocyanate, calcium nitrite and calcium nitrate.

6. The admixture according to claim 4, wherein the setting accelerator is an alkanolamine selected from the group consisting of diethanol amine, methyldiethanol amine, triethanol amine, tetrahydroxyethylene ethylene diamine and triisopropanol amine.

7. The admixture according to claim 1, wherein the dispersant polymer is selected from the group consisting of polyalkoxylated polycarboxylic polymers, polyalkoxylated polyphosphonate polymers, polynaphthalene sulfonates (PNS) or formaldehyde and sulfonated melamin polycondensates (PMS).

8. The admixture according to claim 1, wherein the dispersant polymer is an anionic polymer.

9. The admixture according to claim 1, wherein the dispersant polymer is a polyalkylene oxide polycarboxylate comprising at least 50%, by number of a random linear sequence of structural units (1) and (2) illustrated by the following formulas: 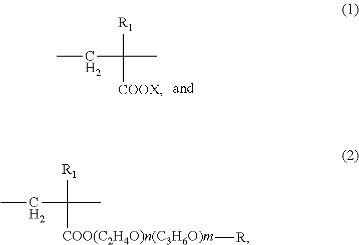
wherein X represents a hydrogen atom, a alkaline metal, an earth-alkaline metal or an ammonium; said structural units (1) may be identical or different; R1 is a hydrogen atom or a methyl group; n is an integer varying from 0 to 120 m is an integer varying from 0 to 100 with m<n; the proplylene oxide groups may be either distributed or not randomly among the ethylene oxide groups R represents a hydrogen atom, an alkyl or alkenyl group with 1 to 24; said structural units (2) may be identical or different; the ratio of the number of structural units (2), over the total number of structural units (1) and (2), being comprised between 5 and 65%

10. The admixture according to claim 9, wherein X is a hydrogen atom or an earth alkaline cation.

11. The admixture according to claim 1, having a pH comprised between 3 and 10.

12. A method for preparing an admixture according to claim 1, comprising:
(1) providing an aqueous solution of mineral nanoparticles;
(2) adding a dispersant polymer;
(3) adding a setting accelerator; and
(4) optionally if necessary, adjusting the pH to a value from 2 to 11.

13. The method for preparing a hydraulic composition, comprising the addition of a suitable dose of the admixture according to claim 1 to the hydraulic binder.

14. The method according to claim 13, wherein the admixture is added with a dose from 500 to 10,000 ppm by dry weight based on the weight of the hydraulic binder.

15. The method according to claim 13, wherein the admixture comprises from 1 to 95% by weight of nanoparticles.

16. A method of accelerating the setting of a hydraulic composition comprising adding the admixture according to claim 1 to the hydraulic composition.

17. The admixture of claim 9, wherein said dispersant comprises at least 75% by number of a random linear sequence of structural units (1) and (2).

18. The admixture of claim 9, wherein R represents an alkyl or alkenyl group with 1-18 carbon atoms.

19. The admixture of claim 9, wherein the ratio of the number of structural units (2), over the total number of structural units (1) and (2), is between 40 and 60%.

20. The admixture according to claim 9, wherein X is a calcium cation
